(19) United States
(12) Patent Application Publication
(10) Pub. No.: US 2006/0229064 A1
(43) Pub. Date: Oct. 12, 2006

(54) Interface for transmitting trace information

(76) Inventors: Antti Pitkamaki, Tampere (FI); Arvo Mansikka, Oulu (FI)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(21) Appl. No.: 10/562,587

(22) PCT Filed: Jun. 29, 2004
(86) PCT No.: PCT/FI04/50108

§ 371 Date: Jun. 7, 2006

(51) Int. Cl. H04Q 7/22

(52) U.S. Cl. 455/414.3

(57) ABSTRACT

A method for transmitting trace data to a network tester, comprising: tracing data transmission between a mobile terminal and a network, transmitting the trace data by using a standardized interface specification, and controlling, via specific AT commands, the setting of the trace parameters and the communicating of the trace data. The method is applied by a trace system comprising a network tester and a mobile terminal arranged for collecting trace data and for communicating the trace data to the network tester, a standardized interface and control means for setting the trace parameters and for communicating the trace data, controlled with specific AT commands. The network tester of the system arranged to collect trace data which applies to the data transmission, comprises a standardized interface.

The invention relates to a method for transmitting trace data to a network tester according to the preamble of claim 1. In addition, the invention relates to a trace system according to the preamble of claim 8. The invention also relates to a terminal according to the preamble of claim 10. The invention also relates to a network tester according to the preamble of claim 13.

Network testers are used to test the traffic between the network terminating mobile terminal (DCE, Data Circuit Terminating Equipment) and the network. In this case, the testing involves especially the interconnection between the terminal, in practice a PC (DTE, Data Terminal Equipment), and the network terminating mobile terminal, in practice a wireless mobile communication device. By means of testing it is possible to monitor the operation of the network from the point of view of the mobile device and, if necessary, to dimension the network settings with the environment and the mobile device in mind. A network tester can also be utilized in testing products already on the market, in which case possible error situations, which have taken place in a normal usage situation are established, and thus the error can be located faster.

The problem with the testing systems in use nowadays is that determining the internal information of a terminal is not possible without exposing the inner architecture of the terminal, and therefore the message traffic on the buses is apparent in the output as well. The terminal manufacturer-specific interfaces and the structure of messages has to be revealed to different tester manufacturers, which can cause problems from the point of view of confidentiality. Another problem connected to network testers is that a part of the trace data is presented in the same form as in connection with the product development of the terminal, so therefore the representation of the data in question at the same time reveals the internal implementation of the protocols of the terminal.

By means of the present invention it is possible to eliminate or at least reduce the above-mentioned problems. The method according to the invention is characterized in what will be presented in the characterizing part of claim 1. The system according to the invention is characterized in what will be presented in the characterizing part of claim 8. The terminal according to the invention is characterized in what will be presented in the characterizing part of claim 10. The network tester according to the invention is characterized in what will be presented in the characterizing part of claim 13.

With the solution according to the invention, the trace data is sent from the terminal to some external device via a standardized interface, a so-called DTE-DCE interface. In the solution the output of the terminal is, in addition, controlled with specific commands, the so-called AT commands. The solution specifically relates to a mobile communication device and a laptop computer, wherein the application used in testing functions.

An advantage of the invention is that the information concerning the trace is obtained from the terminal via such an interface, which is standardized and used especially in all modern laptop computers. Also from the point of view of terminal manufacturers, the solution according to the invention is advantageous, because if the terminal supports external solutions (e.g. dial-up), which use an interface, they can now use the same interface also in testing and tracing the network. The AT commands according to the invention are compatible with the so-called Hayes AT commands (Hayes Standard AT Command Set) according to prior art, along with which the AT commands for tracing according to the invention are now used.

The invention operates e.g. in testing terminals according to the GSM/GPRS and WCDMA systems.

In the following, the invention will be described in more detail by using a preferred embodiment as an example, wherein reference is at the same time made to the appended drawings, in which:

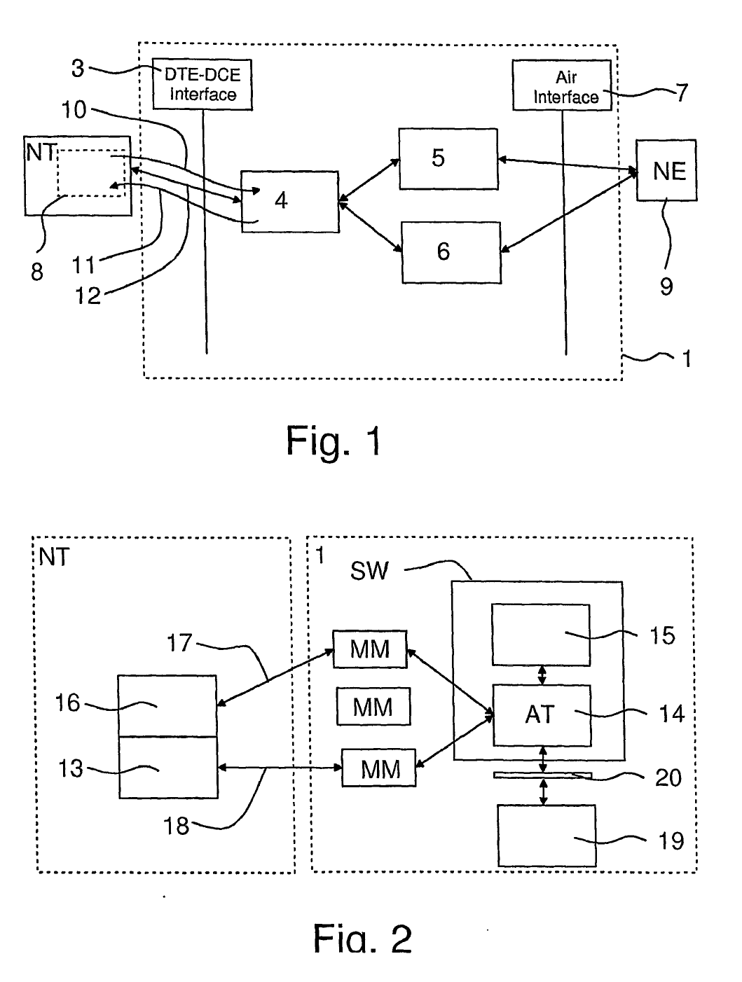

FIG. 1 shows an implementation of the invention as a simplified graph, and

FIG. 2 shows a more detailed architecture of the invention as a graph.

FIG. 1 shows a network tester NT, which receives trace information 11 from the mobile communication device (DCE) outlined in block 1. An interface 3 is used in transmitting information, which interface is in this connection also referred to as the DTE-DCE interface (DTE, Data Terminal Equipment). On the interface 3, at the side of the mobile communication device 1, there is a support element 4, which interprets (AT Command Interpretation) the AT commands (commands 10) and handles the interface 3 (DTE Interface Handling). The element 4 receives the AT commands 10 from the tester NT and transmits the trace data 11 to the tester. Data is received from protocol means 5 (Core Network Protocols) or 6 (Radio access Network Protocols). The mobile communication device 1 is, for its part, connected to the network 9 and its network elements NE via an interface 7 known as such (Air Interface).

The DTE-DCE interface 3 is used to transfer trace information in a similar manner as user data is transferred in normal situations during data transmission. This means that the measurement reports on testing, system information etc. information is, from the point of view of the interface 3, also the user's data, but before the information is sent to the tester NT, it is modified before being given to the interface 3 in such a manner that only the most substantial parts of data are shown. In addition to this, the tracing of system information and packet system information is buffered and delayed (FIG. 2, System Info Storage, block 15) before sending to the interface 3, in which case the internal operation of the mobile communication device 1 can be hidden.

So-called specific AT commands are used in controlling the trace, which commands are introduced next. The first command (e.g. AT*NTESTSYSTEM) is used to set the interface 3 in use to a state, wherein the true user data is not transferred via the interface 3, and in which the AT commands in use are limited to only those commands, which are necessary from the point of view of network testing. Thus, the usage of, for example, the ATD command (selection of the number being called) according to prior art is prevented. The blocking in question is necessary in order to prevent the users from forming a data call by using the same interface 3 during tracing. If the formation of the call in question was possible, the trace data and user data would be mixed in the interface 3 and they could not be separated from each other at the terminal (NT) side.

The second command (e.g. AT*NLOGGING) is used to activate the sending of trace information from the mobile communication device 1 and to set the information format change suitable for the tester NT. Thus, it is, for example, possible to select to change trace information, for example, to either pure binary data or to change the binary data to textual format. The command parameters show what kind of a trace set usage is activated, in which case, for example, all the possible trace information is selected or only, for example, those traces which are connected to measurements. The most suitable output format can also be selected by means of the command parameters.

In addition to the above, there is a set of commands, by means of which the operation of the mobile communication device 1 is controlled. With these commands, for example, the band (band locking) or the channel (channel locking) used by the mobile communication device is locked, or the selection of the cell is controlled (cell barring). The set can be enlarged with new commands when necessary.

The invention is applied in the following manner. First, the user connects the terminal NT to the mobile communication device 1 by using an appropriate manner. The terminal is typically a PC and in the connection it is possible to use a manner known as such, such as an infrared connection (IR, IrDA), a Bluetooth connection, a USB connection or a RS232 connection. The user can connect, in addition to the terminal NT, some other terminal (DTE) in some other manner to the mobile communication device 1 in order to create another connection, if, for example, the user wants to browse Internet pages and to trace how it effects the behaviour of the network. For example, an USB connection supports several simultaneous connections, in which case connecting the terminals is simpler. When the necessary connections have been made, the application 8 used in testing gives AT commands 10 to the mobile communication device 1 to start the trace. After that all the trace information is provided via the interface 3 and the connection 12 to the trace application 8. If some other terminal (DTE) is connected to the mobile communication device 1, the user can use it for normal operations, such as to create a connection (dial-up connection) or to browse the Internet. These two PC connections can be independent of each other. If the user so wishes, he/she can use the application 8 of the tester NT to give AT commands to the mobile communication device 1, by means of which commands, for example, the band is locked. When all the necessary tracing has been performed, the tester NT application gives an AT command to the mobile communication device 1, by means of which command the tracing is stopped and the user can disconnect the terminal (DTE) from the mobile communication device 1.

Next, the different AT commands used in the invention are examined, (< . . . > describes the parameters to be set for the command):
AT*NTESTSYSTEM=<selection>, which enables and disable the network test mode,
AT*NLOGGING=<selection>, which enables and disables information logging,
AT*NBALOCK=<band>, which enables and disables the desired band locking,
AT*NCHLOCK=<oper>,<band>,<channel>, which enables and disables the desired channel locking,
AT*NCELLBARR=<state>, which sets the cell barring, and
AT*NEOTD=<oper>, <max response time>, <position accuracy>, <tracking interval>, which starts a so-called EOTD positioning procedure, in which case the functionality in question makes it possible to calculate the location of the mobile communication device.

The new AT commands are intended to support the testing and to active the collection of PDU information (Packet Data Unit) and parameter information. In the tracing, all the packet data units (PDU) sent to the network and received from it are traced in the mobile communication device. Processing the trace data is performed preferably in a separate device (NT). The parameters of the air interface and the parameters calculated internally in the mobile communication device are traced by requesting information from a protocol entity (e.g. CC, Call Control) or a software component handling their tasks. All the PDU trace information is based on standards known as such.

A new function of the AT command interpreter 14 of a mobile communication device is interpreting these new functions, providing information to be offered as a response from the internal components of a mobile communication device, and returning the responses to external testing systems. The trace messages and responses to requests meant for a protocol entity are transmitted via the AT command interpreter to a network testing system.

In addition to this, the standard AT commands according to prior art are supported, which commands are required in the connection between the tester NT and the mobile communication device 1. The commands control the connection in question and affect only the connection in question. The commands include, for example:
ATE, command echo,
ATV, determine response format,
ATI, request identification information,
ATZ, reset to default configuration,
AT&V, view active configuration, and
AT&F, restore factory settings.

The testing system is implemented by means of, for example, a special application to be connected to a normal mobile communication device to be tested, which receives AT commands by means of a DTE-DCE interface and performs the desired operations.

Let us next examine the architecture and system of the special applications with references to FIG. 2. In the implementation of the system is utilized the AT command interpreter 14 of the mobile communication device 1, to which interpreter the necessary changes are made in order to implement operations according to the invention. The main components of the system are the actual network tester NT, which comprises a test controlling test system unit 16, which also receives the trace information and performs requests to the protocol entity. In the scope of this description, also the connection control unit 13 belongs to the same physical device with the tester NT, which unit creates the call or the packet data transfer and whose functionality the network tester NT traces. Data transmission between the network test system NT and different media modules MM (including a so-called terminal adapter) depends on the medium being used, of which for example infrared connection (IrDA) was mentioned above. Each connection by means of a different medium is described as a separate session. A logical connection to the AT command interpreter is created for each physical connection 17 and 18 of the media module MM. There can also be several of these connections (e.g. USB connection), in which case the network tester can be handled as two sessions in the AT command interpreter. One session is for tracing and controlling the functionality of the tester, and the other for controlling the actual data connection. The tester NT is, thus, connected to the mobile communication device 1 by means of, for example, one USB connection, or two Bluetooth connections, or a Bluetooth connection and an IrDA connection, or an IrDA connection and a RS232 connection, in order to create two sessions.

In the mobile communication device 1, communication between different units takes place in the same manner as in mobile communication devices intended for normal use. Trace information is obtained by using product development software, wherein there are additional properties in comparison to a normal version. Traces can be activated and deactivated in run-time manner. The protocol units 5 and 6 (FIG. 1) as well as other units send the trace information via the interface 3. Of the traces received from the protocol entity, the so-called system information tracings and the packet system information tracings differ from the others. These traces are not sent directly to the tester NT, because the timings connected to them are confidential information, which is why the traces are stored in the system info storage 15 of the software component SW handling the DTE-DCE interface, for buffering and delaying. After a suitable delay, the component SW sends the stored trace to the tester NT in numeral order.

The tester NT is connected to the mobile communication device 1 in a manner that depends on the physical connection and by means of which the media modules MM (one or two media modules) used by the tester know that the connection has taken place. After this the media modules MM send the necessary messages to the component SW handling the interface, in order to create logical connections 17, 18. By means of the connections the tester NT can send AT commands 10 (FIG. 1) to the AT command interpreter 14, which, for its part, sends a response 11. In the normal mode of the mobile communication device 1, normal AT commands are possible (e.g. AT*CHSN) and the AT commands of the network tester (NT) are not allowed (e.g. AT*NBALOCK) and produce an error. After the command AT*NTESTSYSTEM=1 is given to the mobile communication device 1, the mobile communication device transfers to a network tester mode, and it does not accept normal AT commands any longer, which now only produce an error. In stead, configurations made with normal AT commands are still valid, but they cannot now be changed or presented. In the mode in question, only special AT commands are accepted. At the end of the test session, a command AT*NTESTSYSTEM=0 is given, after which the mobile communication device returns to normal state and the normal AT commands are possible.

When the network tester NT sends a command AT*NLOGGING=1 to the mobile communication device, the trace is activated. The AT command interpreter 14 receives the command in question, acknowledges it and, for its part, sends (e.g. via an internal interface, such as ISI, Inter-System interface) a message to the monitor server 19, in the sub-blocks of which message it is determined which traces should be sent to the component SW handling the DTE-DCE interface. After activation, the trace data is sent to the component in messages, whose content is sent further to the network tester NT. Traces can also be deactivated.

The operation according to the invention requires changes in the AT command interpreter of the mobile communication device and in the functionality control, also in the configurations files, if necessary. For example, one module, which handles the determined new specific AT commands is added to the AT command interpreter. The necessary changes are also made in the internal operation of the interpreter, with which changes e.g. tester commands are prevented if the mobile communication device 1 is not in a network tester mode. The control software core functionality also has to be changed in order to make it possible to receive trace information from the trace component 19 and to give it to the DTE interface 3. The control software of the mobile communication device 1 thus also requires a storage 15 for the system information traces, which, in practice, means e.g. a linked list of received block or several lists.

The responses given to the AT commands are divided into three classes. First of all, standard AT responses (AT command response), which are in ASCII form (ASCII character), come into question. Secondly, ISI trace indication responses, which include trace information (protocol PDU trace), come into question. This trace information is known as such and already used in connection with testing according to prior art, which information is in addition determined in the appropriate protocol standards. A part of the information used in the internal interfaces 20 can be removed before giving the information to the network tester, because the information may be unnecessary. Thirdly, message responses to the requests sent to the protocol entity come into question. The unnecessary fields of the response are, however, removed before sending the final response to the network tester.

In activating the trace, an AT command for logging received from the outside activates several trace groups and requests for protocol entities internally in the mobile communication device 1. The commands are replaced internally with trace activation requests and query requests. There are several external commands in use, which make it possible to collect data selectively and whose internal specification can, in addition, be configured.

The internal trace indication messages and the response messages coming from the protocol entities can be provided with an appropriate prefix before giving them to the network tester, so that the standard AT responses and responses connected to data collection can easily be separated.

The necessary changes in the functionality of the mobile communication device and the software changes are apparent to a man skilled in the art already on the basis of the above presented conditions. The detailed implementation can vary according to needs. The invention is not limited solely to the example presented above, but it may vary within the scope of the appended claims.

What is claimed is:

1. A method for transmitting trace data to a network tester, comprising:
tracing the data transmission between a mobile terminal and a network,
transmitting the trace data by using a standardized interface specification, and
controlling, via specific AT commands, the setting of the trace parameters and the communicating of the trace data.

2. The method according to claim 1, further comprising:
buffering and delaying the trace data in the mobile terminal before its transmission, wherein timings related to the operation of the mobile terminal can be hidden.

3. The method according to claim 2, further comprising:
buffering at least the trace data concerning the system information of the mobile terminal and the packet system information.

4. The method according to claim 1, further comprising:
using, in addition to the specific AT command set, a normal AT command set known as such in controlling the operation of the mobile terminal, but allowing the use of only one command set at a time in controlling the mobile terminal.

5. The method according to claim 1, further comprising:
modifying the trace data to be sent to the network tester into a format, wherein the trace data comprises only the data substantial from the point of view of tracing.

6. The method according to claim 1, further comprising:
using the standardized interface in other data transmission also, wherein the interface is a bus intended for communicating normal user data.

7. The method according to claim 6, further comprising:
using the bus for data transmission between the network tester and the network, from which the trace data is collected simultaneously.

8. A trace system, comprising:
a network tester and a mobile terminal arranged for collecting trace data and communicating the trace data to the network tester, wherein the trace data applies only to the data transmission between the mobile terminal and a network,
wherein the trace system further comprises a standardized interface arranged to communicate the trace data, and control means for setting the parameters of tracing and for communicating the trace data, controlled with specific AT commands.

9. The trace system according to claim 8, wherein the trace system further comprises:
means for buffering and delaying the trace data in the mobile terminal before its transmission to the network tester, wherein the timings related to the function of the mobile terminal can be hidden.

10. A terminal, arranged for data transmission between the terminal and a network, the terminal being further arranged to collect trace data, which applies to said data transmission, and to communicate the trace data further, wherein the terminal comprises:
a standardized interface arranged to communicate the trace data, and control means for setting the parameters of tracing and for communicating the trace data, controlled with specific AT commands.

11. The terminal according to claim 10, wherein the terminal further comprises:
means for buffering and delaying the trace data in the terminal before its transmission further via said standardized interface.

12. The terminal according to claim 10, wherein the terminal further comprises:
means for connecting an external network tester to the terminal, the external network tester being intended for receiving the trace data, for providing said specific AT commands.

13. A network tester arranged for data transmission between a mobile terminal and a network, the network tester being further arranged to collect trace data, which applies to said data transmission, wherein the network tester comprises:
a standardized interface arranged for setting the trace parameters and for communicating the trace data, controlled with specific AT commands.

14. The method according to claim 2, wherein the specific AT commands are of a specific AT command set, the method further comprising:
using, in addition to the specific AT command set, a normal AT command set known as such in controlling the operation of the mobile terminal, but allowing the use of only one command set at a time in controlling the mobile terminal.

15. The method according to claim 2, further comprising:
modifying the trace data to be sent to the network tester into a format, wherein the trace data comprises only the data substantial from the point of view of tracing.

16. the terminal according to claim 11, wherein the terminal further comprises:
means for connecting an external network tester to the terminal, the external network tester being intended for receiving the trace data, for providing said specific AT commands.
